(19) United States
(12) Patent Application Publication
(10) Pub. No.: US 2025/0083349 A1
(43) Pub. Date: Mar. 13, 2025

(54) Hair Removal Extension Device

(71) Applicant: Jonathan Lindén, Stockholm (SE)

(72) Inventor: Jonathan Lindén, Stockholm (SE)

(21) Appl. No.: 18/462,794

(22) Filed: Sep. 7, 2023

(51) Int. Cl. B26B 21/52

(52) U.S. Cl. CPC B26B 21/523

(57) ABSTRACT

The present invention unveils a unique mechanism designed to grip and extend the reach of diverse shaving devices and epilators, encompassing various types and sizes. This device features an elongated handle connected to a universal clamping mechanism via a rotatable joint. This universal clamping mechanism is equipped with a pair of gripping elements, adjustable in relation to each other, enabling it to secure handles from a wide range of shaving devices and epilators. Furthermore, users have the flexibility to adjust the angle between the clamping mechanism and the elongated handle, allowing them to modify the orientation of the held shaving apparatus or epilator as desired.

### COPYRIGHT NOTICE

A portion of the disclosure of this patent document contains material which is subject to copyright protection. The copyright owner has no objection to the facsimile reproduction by anyone of the patent disclosure, as it appears in the Patent and Trademark Office patent files or records, but otherwise reserves all copyright rights whatsoever.

### FIELD OF THE INVENTION

The present invention is in the domain of shaving device accessories. It details an extension arm designed to fit a wide range of shaving devices and epilators. The arm, equipped with an elongated handle and a gripping mechanism, facilitates the securement of the specified device, adjustment of its angle, and its firm locking at the desired position.

### BACKGROUND

Extension arms designed to aid razor blades and shaving devices and epilators in reaching and shaving remote parts of the body are well-known in the art. These handle extensions have been introduced to aid users in comfortably accessing areas beyond the reach of conventional shaving devices. Commonly, such extensions find use in shaving parts of the body like the back and legs.

However, a significant drawback of existing extension arms lies in their limited adaptability to various shaving devices. Many of these arms are tailored to work exclusively with a particular type or brand of shaver or come pre-integrated with a specific shaver, hampering their versatility. This limitation often forces consumers to purchase additional shaving tools, rather than leveraging the devices they already possess. In contrast, the present invention is designed to be compatible with a wider variety of shaving devices, aiming to minimize the consumer's need to invest in redundant equipment. Essentially, a user who already owns a shaving device would simply need this innovative extension arm to conveniently shave the back and other hard-to-reach areas.

Another area where current designs fall short is in allowing precise angular adjustment of the shaver attached to the extension arm. This capability is paramount for ensuring an ergonomic and effective shaving experience, especially when targeting difficult-to-reach zones like the back and legs. The present invention fills this void, enhancing both the comfort and efficiency of the shaving process in these challenging areas.

It is within this context that the present invention is provided

### DESCRIPTION OF THE RELATED ART

A number of patents exist in the realm of shaving device extensions designed to aid users in accessing hard-to-reach areas. The following offers a brief overview of pertinent patents and delineates the distinct attributes of the present invention.

U.S. Pub. No. US2007227015A1 by Collins, Christopher B., discloses an extendable handle specifically for standard cartridge razors to assist in shaving challenging areas. Unlike this patent, the present invention caters to a wider range of shaving devices, allowing angle adjustment and incorporates a distinct locking mechanism.

U.S. Pub. No. US20040107585A1, by Helmrich, Christopher M., showcases an extension arm with an adapter and straps to secure electric shavers. Though it features two hinged junctions for adjusting angles, it lacks the soft gripping pads and the angle-locking feature inherent to my invention.

U.S. Pub. No. US2011094114A1, by Payne-Baggetta, Colleen, focuses on a razor handle assembly tailored to hard-to-reach regions. Contrary to the present invention's compatibility with various shavers, Payne-Baggetta's design is tailored exclusively for non-electric cartridge razors.

DE Pub. No. DE102006044316A1, by Krech Stephan and Rueggeberg Lutz, describes a handle extension designed solely for standard cartridge razors. This stands in contrast to the present invention's adaptability to various shaving devices.

In reviewing the prior patents, individually or collectively, none seem to encompass the full range of features described in the present invention as detailed in the claims.

### SUMMARY

The present disclosure outlines a specialized extender device designed to hold and extend the reach of various epilators and shaving instruments. The device comprises an elongated handle connected to a universal clamping mechanism through a rotatable joint. This clamping mechanism features a split-frame design, branching into two arms, each equipped with gripping pads. These adjustable gripping pads can accommodate different shaving device handles and epilators. By modifying the angle of the clamping mechanism in relation to the elongated handle, the user can also alter the angle of the shaving device, enabling a more ergonomic shaving experience.

In some embodiments, the clamping mechanism utilizes a bolt structure. This structure dictates the linear motion of one arm, adjusting the separation between the gripping pads based on the specific rotational direction of the bolt.

In some versions, a spring-loaded system replaces the bolt mechanism. This spring exerts an inward force on the arms. To attach a shaving device, users separate the arms, position the shaver between the gripping pads, and upon release, the spring-driven motion closes in on the shaving device, ensuring a secure grip.

In certain embodiments, the clamping mechanism uses a dual rack and pinion system as an alternative to traditional spring or bolt mechanisms. By rotating the pinion, a synchronized movement of both gripping pads is initiated. This mechanism ensures that the shaving device remains centered and secured evenly by the gripping pads when in use. Depending on the direction in which the pinion is rotated, it can either draw the pads closer together or push them apart. In some configurations, the pinion is rotated in one direction to bring the pads into proximity, while pressing a designated button causes the gripping pads to separate.

In some embodiments, the clamping mechanism can be manually pressed together, wherein the gripping pads secure the shaving apparatus. An automatic locking mechanism maintains the gripping pads in their clamped position. Furthermore, the clamping mechanism includes a release button; upon its actuation, the locking mechanism disengages, allowing the gripping pads to separate and release the secured shaving apparatus or epilator.

In one configuration, both gripping pads are adjustable with respect to one another, or in another configuration, one pad is adjustable relative to the other while the other pad remains static.

In certain designs, the elongated handle is segmented into multiple sections. These sections are interconnected by joints, and a control button facilitates foldability, rendering it more compact for purposes such as traveling.

A feature in various designs is the rotatable joint between the elongated handle and clamping mechanism, which allows users to change the clamping mechanism's angle. A locking mechanism secures the desired angle.

For clarity, some designs introduce indicative markers on the rotatable joint. These markers provide a visual measure of the angle between the handle and the clamping mechanism.

The gripping pads are crafted from soft or semi-soft materials, selected from a group comprising rubber, silicone, and other similar materials that offer flexibility, ensuring a reliable grip on shaving devices and epilators.

To enhance the grip, some versions of the device feature gripping pads with ribbed or high-friction surfaces.

The gripping pads' surfaces, which face each other, may feature a concave design complemented by a ribbed texture. This combination ensures a secure fit and enhanced grip on the shaving device. Furthermore, the depth of the curvature can either be consistent or vary between the pads in different designs.

In some embodiments, both gripping pads are securely attached to the clamping mechanism, ensuring their symmetrical alignment irrespective of their relative positioning.

In specific configurations, one or both of the gripping pads are affixed to the clamping mechanism via a pivot point. This design allows the pads to tilt, ensuring optimal compatibility and adaptability to various shaving instruments. While tilting is a primary feature, other angular adjustments may also be possible depending on the design.

In certain embodiments, the elongated handle incorporates a telescopic construction, allowing users the flexibility to modify its length. Additionally, the ability to fold the arm provides compactness when the device is not in use.

In another embodiment, the elongated handle made of separate sections that can be detached or connected, providing modularity in handle length.

Another variant offers a non-telescopic, non-foldable, singular structure elongated handle.

### BRIEF DESCRIPTION OF DRAWINGS

Various embodiments of the invention are disclosed in the following detailed description and accompanying drawings.

FIG. 1 illustrates the clamping mechanism of the present invention in an isometric view, where the adjustable arm is shown in a retracted position.

FIG. 2 illustrates the clamping mechanism of the present invention in an isometric view, where the adjustable arm is shown in an extended position.

FIG. 3 illustrates an embodiment of the extender device of the present invention in a perspective view, showing the invention in its folded state.

FIG. 4 illustrates an embodiment of the extender device of the present invention in a side view, showing the invention in its unfolded state.

### DETAILED DESCRIPTION AND PREFERRED EMBODIMENT

The following is a detailed description of exemplary embodiments to illustrate the principles of the invention. The embodiments are provided to illustrate aspects of the invention, but the invention is not limited to any embodiment. The scope of the invention encompasses numerous alternatives, modifications and equivalent; its limits are defined only by the claims.

Numerous specific details are set forth in the following description in order to provide a thorough understanding of the invention. However, the invention may be practiced according to the claims without some or all of these specific details. For the purpose of clarity, technical material that is known in the technical fields related to the invention has not been described in detail so that the invention is not unnecessarily obscured.

The terminology used herein is for the purpose of describing particular embodiments only and is not intended to be limiting of the invention. As used herein, the term “and/or” includes any combinations of one or more of the associated listed items. As used herein, the singular forms “a,” “an,” and “the” are intended to include the plural forms as well as the singular forms, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

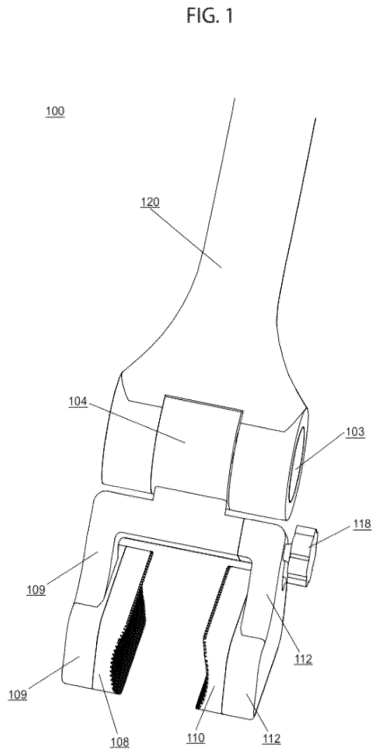

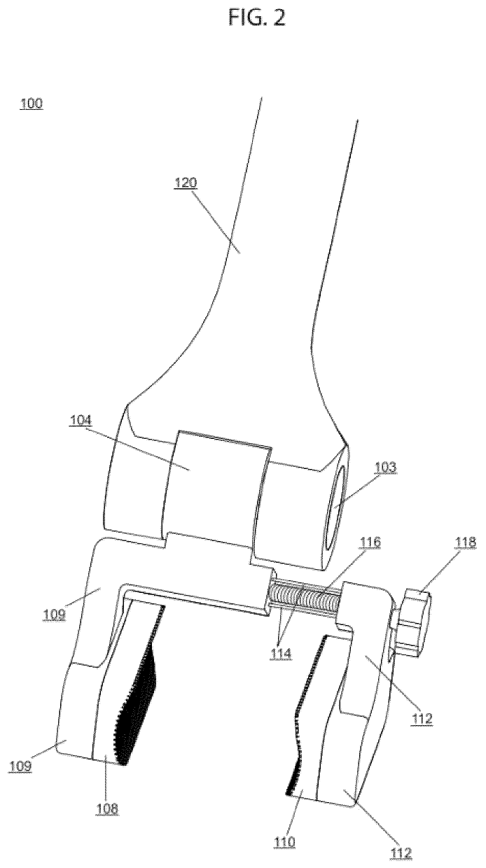

Referring to FIG. 1 and FIG. 2, the figures present a representative embodiment of the clamping mechanism, FIG. 1 depicts the clamping mechanism wherein the adjustable arm 112 is shown in a retracted position in close proximity to static arm 109. FIG. 2 illustrates the adjustable arm in an extended position, widening the gap between the adjustable and static arm, thereby uncovering the threads of the bolt 116 and two parallel pins 114.

The clamping mechanism consists of a split frame segmented into two arms: a static arm 109 and an adjustable arm 112. The static arm 109 has a gripping pad 106 affixed, and the adjustable arm has a gripping pad 110 affixed. The bolt, consisting of a bolt head 118 and the threads of the bolt 116, is also an integral component of the clamping mechanism. The static arm remains fixed relative to the adjustable arm, while the adjustable arm can be altered in orientation with respect to the static arm.

The clamping mechanism is attached to the distal part of arm 120 of the device via a hinged joint. This joint allows for rotation of the clamping mechanism with respect to the distal part of arm 120, thereby facilitating angle adjustments of a held shaver for accessing hard-to-reach areas like the back and legs.

The static arm features a threaded circular opening. When the threads of the bolt 116 engage and rotate within this opening, this action prompts the bolt's linear movement into and out of the static arm 109, determined by the rotational direction of the bolt's threads.

As illustrated in the provided figures, each gripping pad 108, 110 is designed with a ribbed surface. The ribbed texture of the gripping pad enhances grip and its concave design increases contact area with the shaving device, it also ensures a secure fit with the handle of the shaving apparatus. The gripping pads are constructed from materials that can be either soft or semi-soft. Such materials will ensure a firm grip on the shaver, keeping the shaving tool stable and preventing unwanted movement within the grip.

The threads of the bolt 116 are partially enclosed within the adjustable arm 112 at its proximal end adjacent to the bolt head 118. The configuration between the threads of the bolt and the adjustable arm ensures that rotation of the bolt's threads directly initiates movement of the adjustable arm. The placement of the enclosure in relation to the bolt's threads remains fixed, irrespective of the movement or position of the adjustable arm. Within this configuration, the bolt's threads can rotate in respect to the adjustable arm, which directly results in the linear motion of the adjustable arm along the bolt's axis in the direction dictated by the turning direction of the bolt's threads.

The pins 114, parallel to the threads of the bolt 116, are incorporated within the adjustable arm 112, forming a unified structure. The static arm 109 has recesses designed for the pins, enabling them to shift in alignment with the bolt's linear motion.

With the rotation of the bolt's threads 116, the pins continuously maintain their position within the indentations of the static arm 109. This consistent engagement enforces a linear trajectory for the adjustable arm 112, negating any possibility of rotational motion relative to the static arm. The direction of the bolt's rotation determines whether the adjustable arm moves closer to or further away from the static arm 109.

The rotation of the bolt's threads 116 alters the distance between gripping pads 108 and 110. Given that gripping pad 108 is attached to the static arm 109 and gripping pad 110 is linked to the adjustable arm 112, adjusting the bolt head 118 directly affects the spacing between the pads. As the movement of gripping pad 110 aligns with the linear path of the adjustable arm 112, the pads always remain symmetrical, irrespective of their relative positions.

Because the spacing between the gripping elements 108,110 can be changed and the design of these elements is meant to fit a wide range of shaver handle shapes and sizes. This versatility ensures a secure grip on a broad range of shaving devices, such as hair trimmers, body groomers, shavers, lady shavers, manual razors, and more.

The specific configuration described with respect to FIG. 1 and FIG. 2 is merely an example of a suitable clamping mechanism. Other configurations which function using the same or similar principles could also be used.

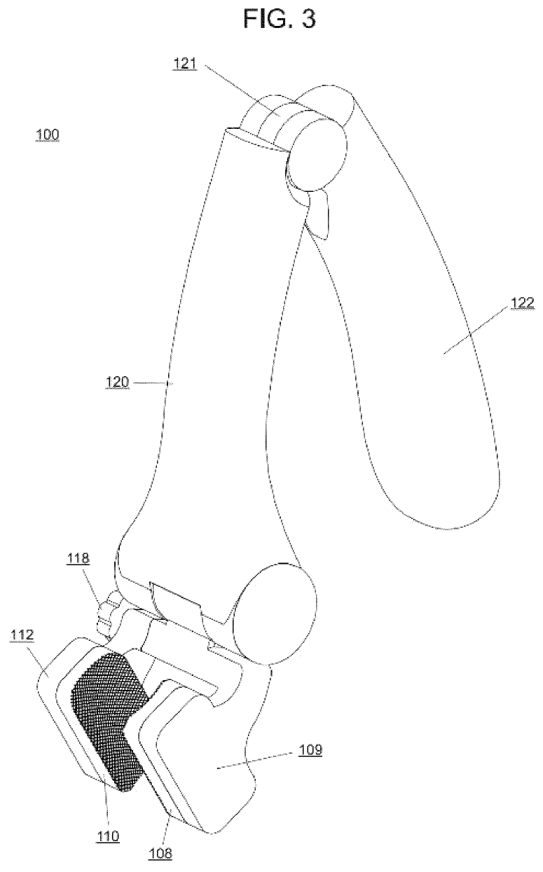

Referring to FIG. 3, a perspective of the full body of the device 100 is displayed, wherein the arm is folded.

In the illustrated example, the handle is divided into a distal part of the arm 120 and a proximal part of the arm 122. These sections are foldable relative to each other. A rotary joint 121 connects the distal part of the arm to the proximal part of the arm. A push button 126 is integrated into the hinge mechanism, as said button is pushed it initiates the folding action

By pressing button 126, the proximal part of arm 122 becomes adjustable, initiating a folding sequence in respect to distal part of arm 120. Releasing the designated button locks the upper part of the arm into its current relative position. Additionally, there are other established folding and locking mechanisms in the field that can function as suitable alternatives to the one outlined here.

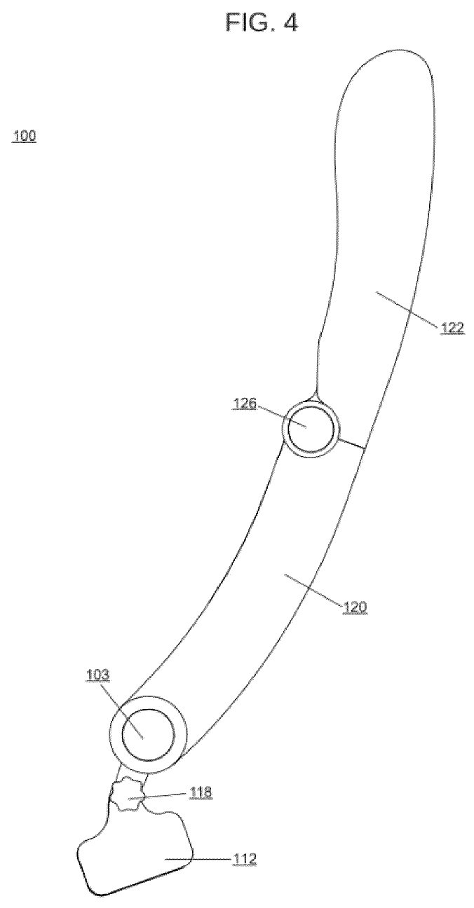

Referencing FIG. 4, a side view of device 100 is displayed, showcasing it in its unfolded state.

The pushbutton 103 functions as an actuator. When engaged, the cylinder 104 becomes mobile and can rotate about its central axis. Given that the static arm 109 and the cylinder 104 are an integral unit, actuating the button allows for adjustment of the angle between the static arm 109 (and consequently the clamping mechanism) and the distal part of the arm 120 (and consequently the whole elongated handle). Upon releasing the pushbutton, this angle becomes set. It should be highlighted that there are analogous locking mechanisms commonly used in the industry. This design characteristic of device 100 allows users to set a particular angle, thereby enabling them to position their shaving device optimally to access hard-to-reach areas.

It should be noted that pushbutton 103 is interchangeable and can be substituted with various other control actuation mechanisms as deemed suitable for the application.

Unless explicitly specified, all terms (inclusive of technical terminologies) used within this document carry the same meaning as typically perceived by someone with standard expertise in the domain to which this invention pertains. It should also be recognized that terms, including those outlined in widely accepted dictionaries, are to be interpreted in alignment with their relevant context in the associated field of study and this specific disclosure. Such terms should not be interpreted in an overly idealized or excessively formal manner unless such a definition is expressly provided in this context.

The embodiments described herein are for illustrative purposes and are not meant to be limiting. Although the apparatus has been detailed in relation to specific representations and configurations, it is understood that the current invention encompasses a broad spectrum of solutions consistent with the scope and essence of the claims.

The described embodiments of the invention are provided as examples and should be construed as illustrative rather than limiting. Any reference to specifics within the illustrated embodiments is not intended to constrain the breadth of the claims. The claims themselves delineate the elements deemed pivotal to the invention.

I claim:

1-18: (canceled)

19: An extender device adapted for holding a shaving apparatus or epilator, the device comprising:
an elongated handle with a proximal end and a distal end;
a rotatable joint attached to the distal end of said elongated handle;
a clamping mechanism operatively coupled to the elongated handle by said rotatable joint, the clamping mechanism incorporates two gripping pads configured to retain a shaving apparatus or epilator; and
wherein one or both of said gripping pads are adjustable to modify the distance relative to the other pad, enabling the gripping of shaving apparatuses or epilators of various dimensions.

20: The extender device of claim 19, wherein the clamping mechanism utilizes a bolt structure to regulate the distance between the gripping pads; wherein turning the bolt structure in a first direction brings one gripping pad closer to a static gripping pad, and turning the bolt structure in a second direction increases the distance between them.

21: The extender device of claim 19, wherein the clamping mechanism incorporates a spring mechanism that pulls one gripping pad towards the other, or pulls both gripping pads towards each other.

22: The extender device of claim 19, wherein the clamping mechanism includes a dual rack and pinion system, such that rotation of the pinion in a first rotational direction causes both gripping pads to converge, and rotation of the pinion in a second, opposite rotational direction causes the gripping pads to diverge.

23: The extender device of claim 22, wherein the clamping mechanism comprises a dual rack and pinion system configured such that rotation of the pinion in a first direction causes both gripping pads to move towards each other for securement, and wherein the gripping pads are adapted to separate from each other upon actuation of a dedicated release button.

24: The extender device of claim 19, wherein the arms of the clamping mechanism are manually pressed together to bring the gripping pads into contact with and secure the shaving apparatus, the device further comprising an automatic locking mechanism that retains the gripping pads in their clamped position, and a release button that, upon actuation, disengages the automatic locking mechanism to allow the gripping pads to separate for releasing the shaving apparatus.

25: The extender device of claim 19, wherein the elongated handle is telescopic, allowing for adjustable length.

26: The extender device of claim 19, wherein the elongated handle comprises multiple sections that are detachable from one another.

27: The extender device of claim 19, wherein the elongated handle is a single, continuous structure.

28: The extender device of claim 19, wherein the elongated handle comprises multiple sections connected by a hinge joint, enabling the sections to fold relative to each other.

29: The extender device of claim 28, further comprising a locking mechanism integrated with the hinge joint and a control button to facilitate the folding and unfolding of the elongated handle.

30: The extender device of claim 19, wherein one or both of the gripping pads are connected to the clamping mechanism in a manner that permits angular adjustments, allowing said gripping pads to make angular adjustments, such as tilting or rotating, with respect to the clamping mechanism.

31: The extender device of claim 19, wherein the connection between the gripping pads and the clamping mechanism is fixed, ensuring that the pads maintain a symmetrical alignment regardless of their relative positions.

32: The extender device of claim 19, wherein the rotatable joint is configured to enable adjustment of the angle of the clamping mechanism in relation to the elongated handle.

33: The extender device of claim 32, wherein the rotatable joint includes a locking mechanism operatively coupled with an actuating element, the actuating element being configured to selectively secure or release the clamping mechanism at a desired angle relative to the elongated handle.

34: The extender device of claim 19, wherein the gripping pads are fabricated from a material exhibiting a soft or semi-soft consistency.

35: The extender device of claim 34, wherein the surfaces of the gripping pads facing the opposite pad are concave and exhibit a ribbed or high-friction texture.

36: The extender device of claim 19, wherein the gripping pads are made of one or more materials selected from a group comprising rubber, silicone, and other similar materials that offer flexibility
